(19) United States
(12) Patent Application Publication
(10) Pub. No.: US 2008/0183863 A1
(43) Pub. Date: Jul. 31, 2008

(54) MONITORING SYSTEM AND METHOD

(75) Inventors: Dustin Delany Hess, Carson City, NV (US); Chad Eric Knodle, Acworth, GA (US); Matthew Allen Nelson, Gardnerville, NV (US); Stephen Robert Schmid, Minden, NV (US); Marc Steven Tompkins, Minden, NV (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 12/024,379

(22) Filed: Feb. 1, 2008

Related U.S. Application Data
(63) Continuation-in-part of application No. 11/552,009, filed on Oct. 23, 2006.

(51) Int. Cl. G06F 15/16

(52) U.S. Cl. 709/224

(57) ABSTRACT

Disclosed is a monitoring system implementing a network including at least one source of dynamic data, the source being in communication with a machine, a monitoring module configured for communication with the source, receiving the dynamic data, and converting the dynamic data to output data for transmittal over the network, a computing resource configured for communication with the network and receiving the output data, a rule implementer in the monitoring module, the rule implementer implementing at least one system rule that is applicable to the output data to determine optimal setpoints for at least one machine variable, and a controller configured for communication with the monitoring module and the network and receiving the output data to which the at least one system rule has been applied, the controller being configured to control the at least one machine variable according to the optimal setpoints.

### CROSS REFERENCE TO RELATED APPLICATION

This application is a Continuation-in-Parts of U.S. Ser. No. 11/552,009, filed Oct. 23, 2006, the contents of which are incorporated by reference herein in their entirety.

### FIELD OF THE INVENTION

The disclosure relates generally to a system for monitoring mechanical systems.

### BACKGROUND OF THE INVENTION

In the field of industrial equipment monitoring, monitoring components may generate various signals representative of dynamic conditions. The signal-generating components are typically sensors and transducers positioned on or otherwise closely associated with points of interest of the machine systems. The signals are used to analyze the performance of the machine system. Machine systems thus instrumented may include rotary machines, assembly lines, production equipment, material handling equipment, power generation equipment, as well as many other types of machines of varying complexity.

A variety of unwanted conditions may develop in machine systems that can occur rapidly, or develop over time in certain situations, such as loading or due to wear or system degradation. Where unwanted conditions appear, various types of response may be warranted. For example, the response of the monitoring components to different dynamic conditions may differ greatly depending upon the machine system itself, its typical operating characteristics, the nature of the system, and the relative importance of the conditions that may develop. Such responses may range from taking no action, to changing operation condition such as speed, load, or lubricant temperature, to further in-depth analysis of waveform data presentations to determine root cause of the condition, to reporting, to logging, to providing alerts, and to energizing or de-energizing parts or all of the machine system.

In order to make such responses, operating information must be analyzed. Machine dynamic data is typically analyzed either in a filtered and/or processed form (such as a filtered peak-to-peak measurement), or as raw dynamic data in a timebase, orbit, or spectrum format. Filtered and processed data may be further analyzed using rules to generate indicators of a specific fault such as imbalance or misalignment. However, operating information from the sensors is much more useful when processed, analyzed, and considered in conjunction with other factors, such as operating speeds, to determine the appropriate response to existing or developing conditions. Therefore, it is beneficial to process the data from all channels simultaneously in time and phase when the machine is in a specific known operating condition.

Responses to monitored signals and processed data may differ due to a number of factors. Again, these may include the normal operating characteristics of the machine system. Also, during certain operating periods, such as during startup or a change in speed or loading, the various ranges may be of greater or lesser interest in deciding upon an appropriate response.

Existing monitoring and protection systems do not provide a desired degree of efficiency in communicating data that is subsequently used to manage machine operations. At times they provide too little dynamic waveform data, sometimes too much dynamic waveform data, or even waveform data collected at the wrong time or operating condition. Waveforms across multiple channels are either unsynchronized or else are synchronized using an additional master module. The resulting solution can be costly and require too large a network bandwidth communicating data, particularly exacerbating current expanding network traffic trends. There is a desire, therefore, for a more efficient, direct approach to using monitoring systems for machine operations, requiring more reasonable communications bandwidth while still collecting the needed data.

In addition to network communications bandwidth constraints, a more efficient solution for changing machine operating conditions is necessary to insure maximizing machine life or improving machine performance or operating efficiency. Current monitoring and protection systems provide alarm events and condition indicators to the operator either directly or via the control system. The operator, possibly in conjunction with other individuals, then has to make decisions and alter the control system programming to optimize the machine operating conditions. This current capability allows the possibility of erroneous decisions being implemented, or those decisions not being timely, or no decisions being made at all.

### BRIEF DESCRIPTION OF THE INVENTION

Disclosed is a monitoring system implementing a network, the system including at least one source of dynamic data, the at least one source being configured to be in communication with a machine, a monitoring module configured for communication with the at least one source, configured for receiving the dynamic data, and configured for converting the dynamic data to output data for transmittal over the network, a computing resource configured for communication with the network, and configured for receiving the output data, a rule implementer in the monitoring module, the rule implementer being configured to implement at least one system rule the at least one rule being applicable to the output data to determine optimal setpoints for at least one machine variable of the machine, and a controller configured for communication with the monitoring module and the network, and configured for receiving the output data to which the at least one system rule has been applied, the controller being configured to control the at least one machine variable according to the optimal setpoints determined by the at least one rule and received by the controller.

Also disclosed is a monitoring method implementing a network. The method including at least one system rule for monitoring at least one condition in a machine; sensing machine conditions of the machine and transmitting a dynamic data stream representative thereof, converting at least a portion of the dynamic data stream to output data, determining optimal setpoints for at least one machine variable from the output data via the at least one system rule, transmitting at least a portion of the output data and the optimal setpoints to a controller, transmitting at least a portion of the output data from the controller to a computer resource, and analyzing at least a portion of the output data via the computing resource, wherein the analyzed output data provides information relating to a health characteristic of the machine

Further disclosed is a monitoring system implementing a network. The system includes at least one source of dynamic data, the source configured to be in signal communication with a machine, a monitoring module configured for communication with the at least one source, configured for receiving the dynamic data, and configured for converting the dynamic data to filtered measurements and waveforms captured simultaneously and synchronously in time and phase across a plurality of channels for storage and subsequent transmittal over the network, a controller being in direct communication with the monitoring module to receive the output data directly form the monitoring module, the controller also being in communication with the network, a computing resource configured for communication with the network, and configured for receiving the output data, and a rule implementer in the monitoring module, the rule implementer configured to receive at least one system rule from the computing resource either directly or via the controller, and implement the at least one system rule the at least one system rule being configured to determine an optimal setpoint for at least one machine variable.

### BRIEF DESCRIPTION OF THE DRAWINGS

The following descriptions should not be considered limiting in any way. With reference to the accompanying drawings, like elements are numbered alike:

FIG. 1 is a schematic illustration of a monitoring system in accordance with an embodiment of the invention;

FIG. 1a is a schematic illustration of the process functions implemented within the Field Programmable Gate Array (FPGA);

FIG. 1b is a graphic representation illustrating waveform, timing signal, and phase relationship; and

FIG. 2 is a block diagram illustrating a monitoring method in accordance with an embodiment of the invention.

### DETAILED DESCRIPTION OF THE INVENTION

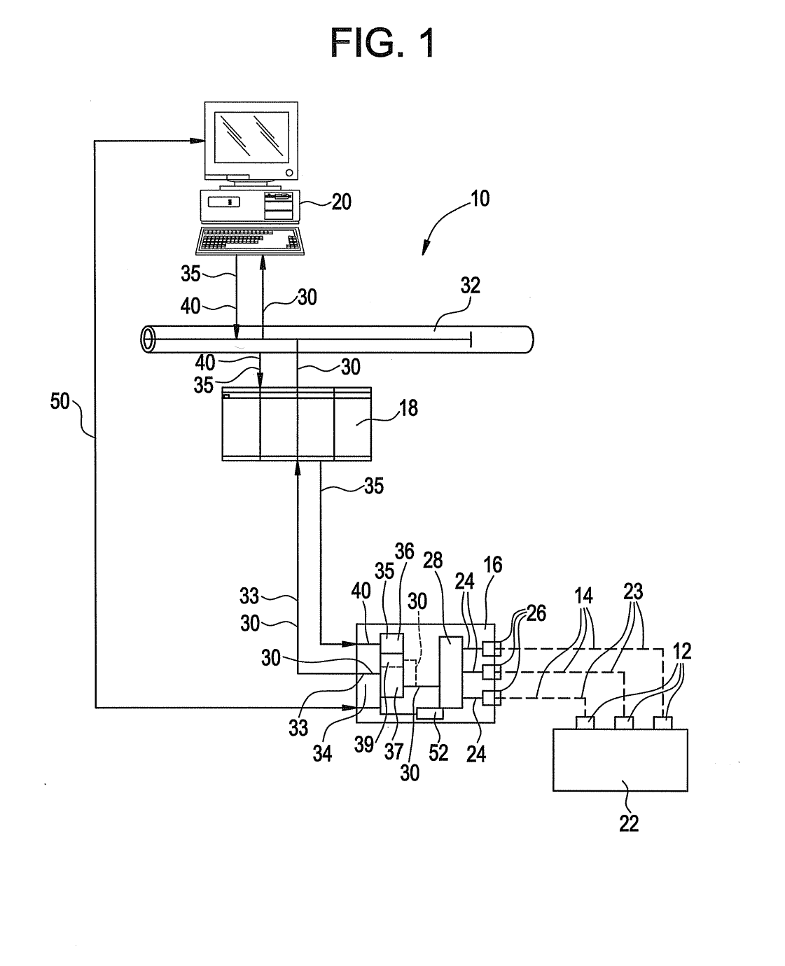

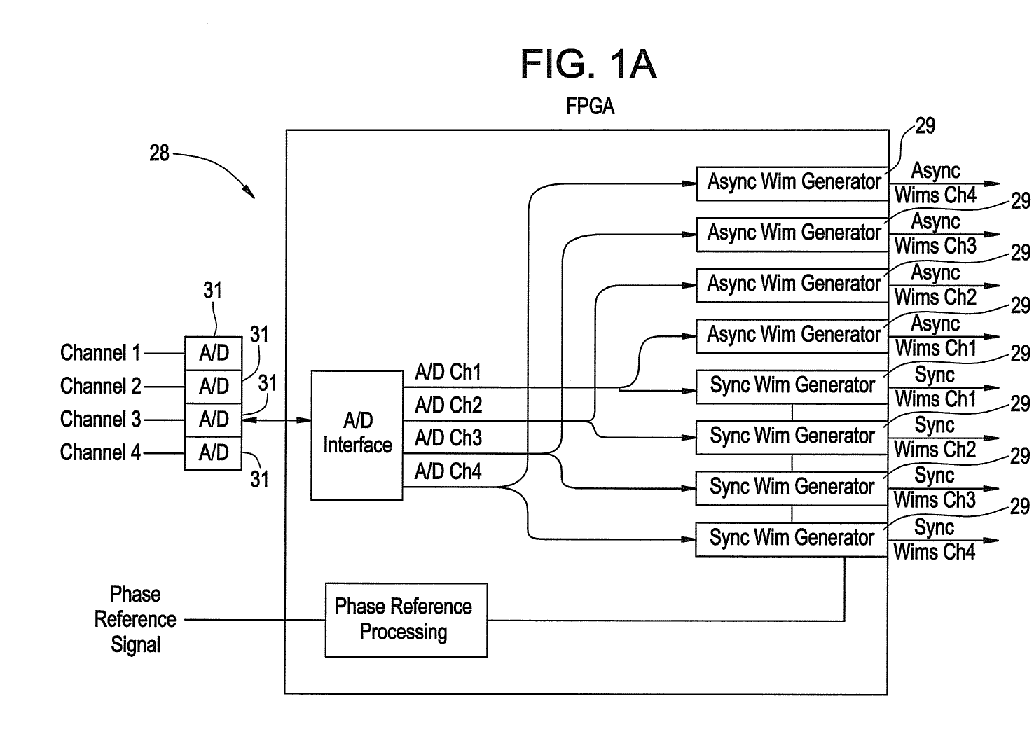

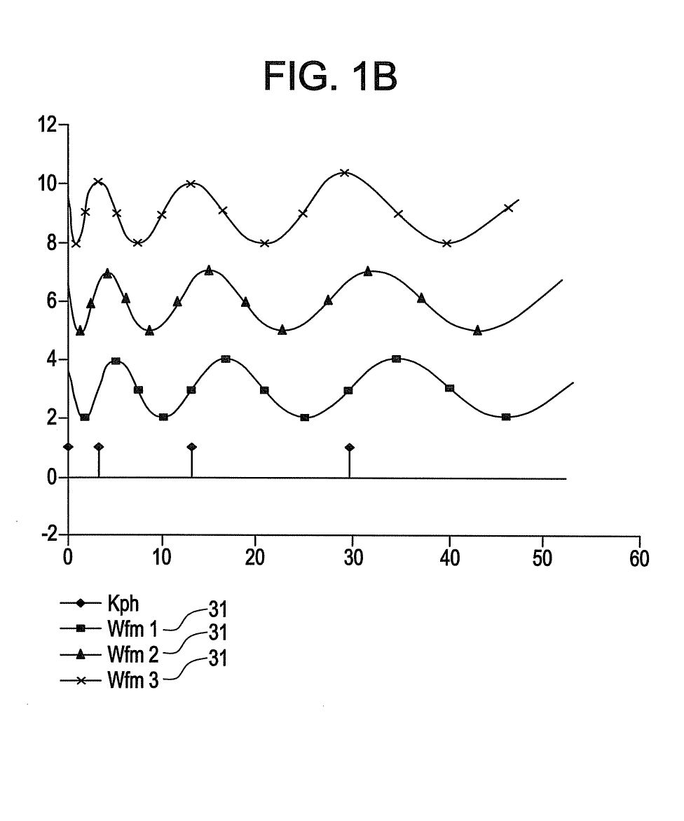

Referring to FIG. 1, a monitoring system 10 is illustrated. The system 10 includes at least one source 12 of dynamic data 14 (in the form of an analog signal 23, as described below), a monitoring module 16, a controller 18, and computing resource 20. The components of the system 10 allow for a two-way transmission of data, which will be discussed hereinbelow, beginning with acquisition of the dynamic data 14 from the at least one source 12.

The at least one source 12 of the dynamic data 14 may be a plurality of sensing systems, such as sensors or transducers that are associated with any type of machine 22, such as rotary machines, assembly lines, production equipment, material handling equipment, and power generation equipment. The acquired dynamic data 14 may pertain to conditions of the machine 22, such as pressure, temperature, or vibration. When acquired by the sources 12 (sensing systems), the dynamic data 14 is in raw, analog form, containing large quantities of information.

After sensing and acquiring the dynamic data 14 in analog form, each sensing system 12 transmits the analog signal 23 (briefly mentioned above) containing dynamic data 14 to the monitoring module 16. These sensing systems 12 are configured to be in signal communication with the monitoring module 16, via, for example, electrical, electromagnetic, or fiber-optical connection. The monitoring module 16 receives the dynamic data 14 via each analog signal 23, and converts it into digital data 24 via analog/digital (A/D) converters 26 associated with the monitoring module 16. In an embodiment, the conversion to digital data 24 is provided by A/D software disposed within the monitoring module 16.

The monitoring module 16 may also include a field programmable gate array 28 for first level processing of the data from the A/D converters 26. The field programmable gate array (FPGA) 28 is a semiconductor device containing programmable logic components and programmable interconnects. The programmable logic components can be programmed to duplicate the functionality of basic logic gates. These logic gates are computer circuits with several inputs but only one output, allowing each gate, and therefore the FPGA 28 as a whole, to act as a data filter for condensing large quantities of information contained in a data stream, such as the digital data 24 of the system 10. In this manner, digital data 24 is converted to output data 30 via the FPGA 28, with the output data 30 having a more desirable bandwidth (smaller bandwidth due to a condensing and filtering of the information) for transmission over a network 32. It should be noted that, as the name implies, the FPGA 28 is “field programmable,” and thus, can be programmed after a manufacturing process by a customer/designer so that the FPGA 28 can perform whatever logic function is desired.

Referring to FIG. 1a, first level processing of data 24 from the A/D converters 26 includes dynamic waveform decimation filtering and sample rate synchronization to an external timing signal. For machine condition monitoring measurements, it is important in an exemplary embodiment that the dynamic waveforms be processed simultaneously, synchronously, and in-phase across all channels. The parallel processing capabilities of an FPGA 28 are well suited for this task. The FPGA 28 design includes a plurality of waveform generators 29 that create and synchronize waveforms from input channels 31.

Referring to FIG. 1b, the process by which output data (which, in an exemplary embodiment is filtered measurements and waveforms) is captured simultaneously and synchronously in time and phase across a plurality of channels 31 is further described. The Kph trace is the timing signal related to the machine speed. In this example, the machine speed is slowing down as evidenced by the period increasing (speed decreasing) with each revolution event. The synchronous sampling process across the three channels 31 maintains the absolute phase relationship between each waveform and timing signal and the relative phase between each of the signal waveforms even through the changing speed condition.

FIG. 1b demonstrates the sampling performed in the Sync Wfm Generator blocks shown in FIG. 1a. FIG. 1a also shows Async Wfm Generator blocks that create waveforms without regard to an external timing signal. The Async Wfms are still synchronized in time, but maintain a constant sample rate and do not have an absolute phase reference.

As shown in FIG. 1a, data is created in the FPGA 28, where parallel waveform generators are used to take advantage of the parallel processing architecture of the FPGA 28. This architecture is well suited to generation waveforms across multiple channels processed using multiple timing signals.

The monitoring module 16 may further include an additional processor 34 (additional to the FPGA 28) that provides data compression and implementation of system rules 35. Data compression, which may be implemented via software 37 installed in the monitoring module 16 (particularly in the additional processor 34), is a process of encoding information using fewer bits (or other information-bearing units) than an unencoded representation would use through use of specific encoding schemes. Data compression algorithms usually exploit statistical redundancy in such a way as to represent data more concisely, but completely. Data compression in the system 10 may further compress the ouput data 30 from the FPGA 28 into data compressed output data (which will be referred to hereinafter and in the FIG. as output data 30), further reducing output data bandwidth for transmission over the network 32 or for storage within the monitor for later upload.

As mentioned above, the additional processor 34 also implements the system rules 35 of the system 10. These rules 35 determine what dynamic data 14 from each source 12 is important, with importance being determined relative to different condition (temperature, vibration, pressure, etc.) thresholds within the machine 22 (or different machines) during different operating periods of the machine 22, such as startup, a change in machine speed, or loading. The system rules 35 are implemented by at least one rule implementer 36 such as change detection filters and threshold detectors based on operating conditions of the machine 22. These rules 35 determine what output data 30 is important enough to be transmitted from the monitoring module 16 to the controller 18 for eventual machine diagnostics in the controller 18 or computing resource 20, based on the output data 30 transmitted. The rule discussed immediately below is an exemplary embodiment of a rule used to determine whether the data should be collected and sent to the controller 18 or computing resource 20 for analysis. The exemplary embodiment is directed to dragline/bucket load (again, by way of example), wherein IF the dragline is reeling in AND the bucket load is N tons AND the spool speed has reached M rpm AND Time>1 hour since the last waveform was stored) THEN store waveforms across all spool channels

The additional processor 34 also applies system rules 35 to the output data 30 to determine optimal setpoints 33 for at least one machine variable (i.e. temperature, vibration, pressure, etc.) of the machine 22. The additional processor 34 may further include a multi-variable analysis algorithm that provides feedforward, plural variable control techniques to determine the optimum setpoints 35 for at least one machine variable. This is described in more detail in U.S. Pat. No. 5,488,561, the content of which is hereby incorporated by reference. The rule discussed below is a simplified exemplary embodiment of the above referenced algorithm, and the manner in which this algorithm may be used to create instructions for the controller (these instructions being directed to changing an operational setpoint). The exemplary embodiment of the algorithm is directed to oil supply (again, by way of example), wherein IF ((mode=STEADY_STATE) AND (0.3×<subsynchronous_peak_vibration_frequency<0.5×) AND (subsynchronous_peak_vibration_amplitude>threshold) AND (low_limit<OIL_SUPPLY_TEMP<high_limit) THEN change oil supply temperature by 2 degrees.

In the above example, the monitoring module 16 verifies that the machine has been operating in a steady state which for this particular machine means the speed has not changed significantly for 5 minutes. From the vibration data the monitoring module 16 determines if the highest synchronous vibration frequency is between 0.3× and 0.5× of running speed and whether or not the amplitude has exceeded a set threshold. For this given machine, this condition indicates a fluid induced instability that can be relieved by changing the lube oil temperature. The rule also checks the lube oil temperature to see if there is room for an adjustment, and if so, makes a recommendation to change the lube oil temperature by an incremental amount. The monitoring module 16 and controller 18 form a feedback control system, wherein the monitoring module 16 may continue to request the change in oil supply temperature until either the instability is reduced or the allowable limit is reached. The monitoring module 16 may further include a memory device 39 for temporary storage of the output data for subsequent transmission to the controller 18 or computing resource 20.

The controller 18 is configured to be in signal communication with the monitoring module 16, via electrical, electromagnetic, or fiber-optical connection, for example, and may be any known control system, such as a programmable logic controller (PLC) or a distributed control system (DCS). The controller 18 uses the optimized setpoints 33 included in the output data 30 to make adjustment to the machine 22. Along with making these determinations, the controller 18 transmits the output data 30 to the computing resource 20 via the network 32, to which the controller 18 is communicated via electrical, electromagnetic, or fiber-optical connection.

The computing resource 20 is also in communication with the network 32 via a wired or wireless electrical, electromagnetic, or fiber-optical connection. The computing resource 20, which may be any type of server or computer, is located remotely of the controller 18, monitoring module 16, data sources 12, and machine 22. Data can be both received by the computing resource 20 from the controller 18, and transmitted from the computing resource 20 to the controller 18. For example, the system rules 35 may be initially transmitted from the computing resource 20 to the controller 18 via the network 32. The controller 20 further applies the rules 35 to operating parameters of the machine 22, and transmits rules 35 to the rule implementer 36 of the monitoring module 16 for implementation. The initial set of system rules 35 created by the computing resource 20 may be implemented until output data 30 reaches the computing resource 20 (via the system 10 components), is analyzed by the computing resource 20, and demonstrates that a change to the system rules 35 would be desirable. When change is desirable, the computing resource 20 will send a change signal 40 to the controller 18, which will instruct the monitoring module 16 to change parameter(s) of the system rules 35. This change in the system rules can be desirable due to age of the machine 22 or its components, demand on the machine 22, and change in machine environment.

Referring to connection 50 of FIG. 1, it should be appreciated that a computing system 20, which may be transportable (i.e. a laptop), may be transported to the site of the monitoring module 16 (becoming non-remote), and be directly connected with the monitoring module 16. The computing resource 20 may upload system rules 35 or adjustments to system rules 35 directly to the monitoring module via this direct connection 50. In addition, in an exemplary embodiment, the monitoring module may include memory storage software 52 that stores output data 30 (as selected by the system rules 35 currently implemented), which may be accessed by a user of the computing resource 20 (which may be any computing option) via the direct connection 50. Likewise, a separate network or a portable memory media such as a USB memory stick may be used to transport rule configuration and output data between the monitor module 16 and the computing resource 20.

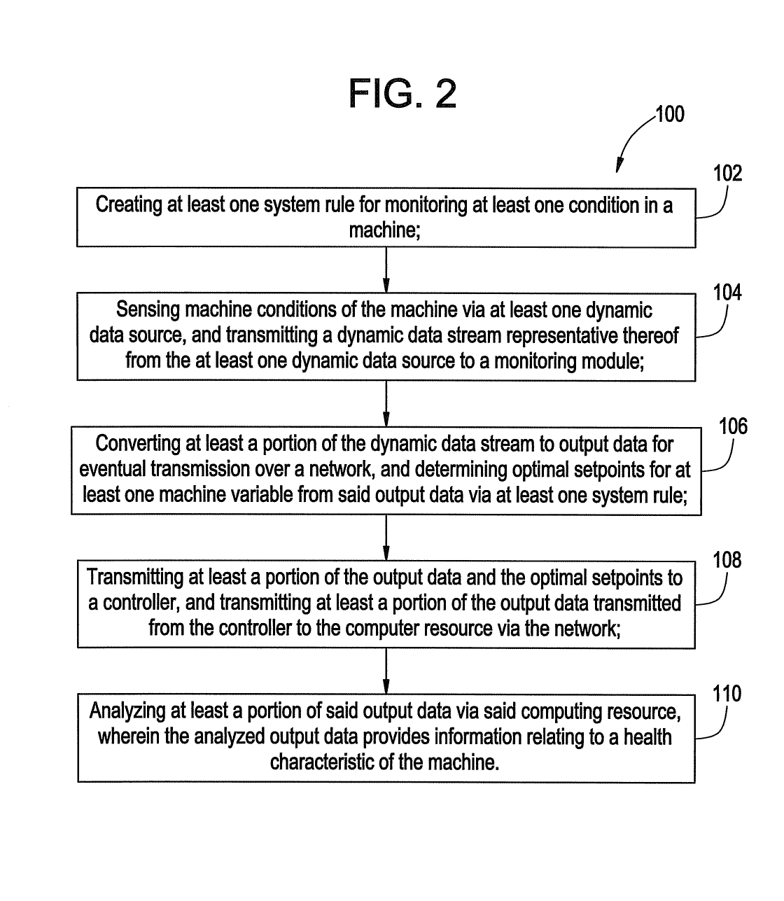

Referring to FIG. 2, a monitoring method 100 is illustrated and includes creating at least one system rule 35 for monitoring at least one condition in a machine 22, as shown in operational block 102, the at least one system rule 35 being created by a computing resource 20. The method 100 also includes sensing machine conditions of the machine via at least one dynamic data source 12, and transmitting a dynamic data stream 14 representative thereof from the at least one dynamic data source 12 to a monitoring module 16, as shown in operational block 104. The method 100 further includes converting at least a portion of the dynamic data stream 14 to output data 30 (comprising filtered measurements and waveforms captured simultaneously and synchronously in time and phase across a plurality of channels according to the results of the rule) for eventual transmission over a network 32, and determining optimal setpoints 33 for at least one machine variable from said output data via at least one system rule 35, as shown in operational block 106. The method 100 additionally includes transmitting at least a portion of the output data 30 and the optimal setpoints 33 to a controller 18, and transmitting at least a portion of the output data 30 transmitted from the controller 18 to the computer resource 20 via the network 32, as shown in operational block 108. The method 100 also includes analyzing at least a portion of the output data 30 with the computing resource 20, wherein the analyzed output data 30 provides information relating to a health characteristic of the machine 22, as shown in operational block 110.

While the embodiments of the disclosed method and apparatus have been described with reference to exemplary embodiments, it will be understood by those skilled in the art that various changes may be made and equivalents may be substituted for elements thereof without departing from the scope of the embodiments of the disclosed method and apparatus. In addition, many modifications may be made to adapt a particular situation or material to the teachings of the embodiments of the disclosed method and apparatus without departing from the essential scope thereof. Therefore, it is intended that the embodiments of the disclosed method and apparatus not be limited to the particular embodiments disclosed as the best mode contemplated for carrying out the embodiments of the disclosed method and apparatus, but that the embodiments of the disclosed method and apparatus will include all embodiments falling within the scope of the appended claims.

An embodiment of the invention may be embodied in the form of computer-implemented processes and apparatuses for practicing those processes. The present invention may also be embodied in the form of a computer program product having computer program code containing instructions embodied in tangible media, such as floppy diskettes, CD-ROMs, hard drives, USB (universal serial bus) drives, or any other computer readable storage medium, such as random access memory (RAM), read only memory (ROM), or erasable programmable read only memory (EPROM), for example, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to perform implementation of a network via a monitoring system or method.

What is claimed is:

1. A monitoring system implementing a network, the system comprising:
at least one source of dynamic data, said at least one source configured to be in communication with a machine;
a monitoring module configured for communication with said at least one source, configured for receiving said dynamic data, and configured for converting said dynamic data to output data for transmittal over the network;
a computing resource configured for communication with the network, and configured for receiving said output data;
a rule implementer in said monitoring module, said rule implementer configured to implement at least one system rule said at least one rule being applicable to said output data to determine optimal setpoints for at least one machine variable of said machine;
a controller configured for communication with said monitoring module and the network, and configured for receiving said output data to which said at least one system rule has been applied, said controller being configured to control said at least one machine variable according to said optimal setpoints determined by said at least one rule and received by said controller.

2. The system according to claim 1, wherein said output data is filtered measurements and waveforms captured simultaneously and synchronously in time and phase across a plurality of channels

3. The system according to claim 1, wherein said at least one system rule is configured to determine whether said output data converted from said dynamic data from each of said at least one sources will be transmitted to said controller for transmittal over said network.

4. The system according to claim 1, wherein said controller is configured to implement change to said at least one machine variable based on said optimal setpoints included in said output data and received from said monitoring module.

5. The system according to claim 1, wherein said output data is configured to be analyzable by said computing resource, and said system rules are configured to be modifiable based on analyzation of said output data.

6. The system according to claim 1, wherein said at least one source of dynamic data comprises a plurality of sensing systems positioned to sense machine conditions within said machine, each of said plurality of sensing systems configured for transmitting an analog signal of said dynamic data to said monitoring module.

7. The system according to claim 1, wherein said monitoring module is configured to include an analog/digital converter channel for said dynamic data transmitted from each of said at least one source, said analog/digital converter channels configured for converting said dynamic to digital data.

8. The system according to claim 2, wherein said monitoring module includes a field programmable gate array configured to generate continuous dynamic waveform samples that are substantially synchronized in phase across a plurality of input channels.

9. The system according to claim 1, wherein said monitoring module includes dynamic data storage capabilities, with said system rules configured to determine what dynamic data should be stored.

10. The system according to claim 1, wherein said computing resource is disposed remotely to said at least one source, said monitoring module, and said controller.

11. The system according to claim 1, wherein said computing resource is configured to directly connect to said monitoring system.

12. The system according to claim 1, wherein said computing resource creates and modifies said at least one system rule.

13. A monitoring method implementing a network, the method comprising:
creating at least one system rule for monitoring at least one condition in a machine;
sensing machine conditions of said machine and transmitting a dynamic data stream representative thereof;
converting at least a portion of said dynamic data stream to output data;
determining optimal setpoints for at least one machine variable from said output data via said at least one system rule;
transmitting at least a portion of said output data and said optimal setpoints to a controller;
transmitting at least a portion of said output data from said controller to a computer resource; and
analyzing at least a portion of said output data via said computing resource,
wherein said analyzed output data provides information relating to a health characteristic of said machine.

14. The method according to claim 13, further comprising:
modifying said at least one system rule based on said analyzing.

15. The method according to claim 13, wherein said creating occurs in said computing network.

16. The method according to claim 13, wherein said transmitting of said at least a portion of said output data from said controller to said computer resource occurs via the network.

17. The method of claim 13, further including controlling said machine variable via said controller based on said optimal setpoints.

18. A monitoring system implementing a network, the system comprising:
at least one source of dynamic data, said source configured to be in signal communication with a machine;
a monitoring module configured for communication with said at least one source, configured for receiving said dynamic data, and configured for converting said dynamic data to output data for transmittal over the network;
a controller being in direct communication with said monitoring module to receive said output data directly form said monitoring module, said controller also being in communication with the network;
a computing resource configured for communication with the network, and configured for receiving said output data; and
a rule implementer in said monitoring module, said rule implementer configured to receive at least one system rule directly from said controller, and implement said at least one system rule, said at least one system rule being configured to determine an optimal setpoint for at least one machine variable.

19. A system according to claim 18, wherein said at least one system rule determines whether at least a portion of said output data should be transmitted to at least one of said controller and said computer resource for machine diagnostics based on said at least a portion of said output data.

20. A system according to claim 18, wherein said at least one system rule determines whether at least a portion of said output data should be stored in memory storage software disposed in said monitoring module to be accessed by said computer resource for machine diagnostics based on said at least a portion of said output data.

21. The method of claim 18, wherein said computing resource is in direct connection with said monitoring module, wherein said output data is transmittable
from said monitoring module directly to said computing resource.
